(19) United States
(12) Patent Application Publication
(10) Pub. No.: US 2015/0371182 A1
(43) Pub. Date: Dec. 24, 2015

(54) USAGE-BASED CARGO PROTECTION

(71) Applicant: Frequentz Inc., Palo Alto, CA (US)

(72) Inventors: Michael T. Lucas, Solona Beach, CA (US); Frank Joseph Terzoli, San Diego, CA (US)

(21) Appl. No.: 14/313,986

(22) Filed: Jun. 24, 2014

(51) Int. Cl. G06Q 10/08

(52) U.S. Cl. CPC G06Q 10/0832; G06Q 40/08

(57) ABSTRACT

A computer-implemented method for managing a usage-based insurance policy for a cargo-handling conveyance is initiated with pre-registration of the cargo-handling conveyance by recording a unique cargo-handling conveyance identifier. Next, usage-based insurance of the cargo is requested by transmitting, over a communications network, location parameters of the cargo-handling conveyance and one or more article identifiers representing the one or more articles. Using the one or more article identifiers to query a source location database known source locations of the one or more articles are obtained. The known source locations of the one or more articles are compared with the cargo-handling conveyance location parameters and a first premium rate is computed and the unique cargo-handling conveyance identifier and is associated with a usage-based cargo insurance policy having the first premium rate in a policyholder database. These actions may be performed using a computer program product, a computing system, or both.

### BACKGROUND

In a typical seafood supply chain, fish farmers and fishermen produce or capture fish and pass the fish on to a wholesaler or supplier. After receiving the fish, the wholesaler may add value by preparing products or may sell the fish unmodified. Retail shops, restaurants and consumers receive the end product fish from the wholesaler through a distribution system. During transport of a catch of fish between a farm or fishing location and a receiving port where it is transferred to a wholesaler or supplier, the catch is at risk for damage or loss.

In an effort to reduce their exposure to risk of damage and loss, farmers or seafood transporters as well as fishermen and fishing vessel operators, typically take out an insurance policy from an insurance provider. Insurance providers assess risk and calculate premiums for protecting property of the seafood transporters and fishing vessel operators based on many factors. The accuracy with which these providers are able to asses, manage and/or mitigate risk and properly price their premiums has great impact the profitability of both the insurance provider and the insured seafood transporters and fishing vessel operators.

Yet despite the importance of these functions to the insurance industry, previous practices have failed to take into account information that may greatly increase accuracy and reliability of risk assessment, premium determinations and the effectiveness and benefits of risk control measures. For example, insurance policies typically cover a given vessel with a blanket policy based upon estimated annual cargo volume. However, this effectively insures a vessel at one premium rate even during times when cargo is not being transported or when just a small amount of cargo is being transported.

Insurance providers may benefit from improved reliability of risk assessment and premium determination with more accurate and relevant information about vessel routes. Regions of environmental hostility represent higher risk. For example, seafaring vessels and their catch are often lost when travelling through the South China Seas and East Indies where 293 accidents were recorded between 1999 and 2011. Insurance providers also desire to reduce incidents of insurance fraud. Fishing vessel operators may have captured a species of fish other than that for which they are insured. Any resulting loss claim may be more expensive than what the insurance provider contracted for. Up-to-date location information enables higher incidence of fraud detection.

Further, there is an increasing sensitivity to the sustainability of fishing and the seafood caught. Unscrupulous fishing vessel operators may attempt to circumvent sustainable practices through fraud, unregulated fishing or simply fishing illegally. Fraudulent, unregulated and illegal fishing results in a higher incidence of accidents, undercuts the compliant vessel operations and threatens to accelerate depletion of fish populations.

### SUMMARY

In one aspect, the present disclosure seeks to provide a computer-implemented method for managing a usage-based insurance policy for a cargo-handling conveyance. The method includes pre-registering the cargo-handling conveyance by recording a unique cargo-handling conveyance identifier; requesting usage-based insurance of the cargo by transmitting, over a communications network, location parameters of the cargo-handling conveyance and one or more article identifiers representing the one or more articles; using the one or more article identifiers to query a source location database to obtain known source locations of the one or more articles; comparing the known source locations of the one or more articles with the cargo-handling conveyance location parameters; and computing a first premium rate and associating the unique cargo-handling conveyance identifier with a usage-based cargo insurance policy having the first premium rate in a policyholder database.

In another aspect, a computer program product for managing a usage-based insurance policy for a cargo-handling conveyance is provided. The computer program product may reside on a non-transitory computer-readable storage medium and comprise instructions which, when executed by a processor cause one or more computers to perform a number of actions. The one or more computers, in response to execution of the instructions, perform actions to pre-register the cargo-handling conveyance by recording a unique cargo-handling conveyance identifier; request usage-based insurance of the cargo by transmitting, over a communications network, location parameters of the cargo-handling conveyance and one or more article identifiers representing the one or more articles; query, using the one or more article identifiers, a source location database to obtain known source locations of the one or more articles of the cargo; compare the known source locations of the one or more articles with the cargo-handling conveyance location parameters; and compute a first premium rate and associate a usage-based cargo insurance policy having the first premium rate with the unique cargo-handling conveyance identifier in a policyholder database.

In another aspect, the present disclosure also seeks to provide a system for managing a usage-based insurance policy for a cargo-handling conveyance. The system includes a pre-registration server, a registration client, a source search engine, a comparison engine and an underwriting engine. The pre-registration server is configured to pre-register the cargo-handling conveyance by recording a unique cargo-handling conveyance identifier. The registration client is configured to, in response to collecting, by the cargo-handling conveyance, a cargo comprising one or more articles, request usage-based insurance of the cargo by transmitting, over a communications network, location parameters of the cargo-handling conveyance and one or more article identifiers representing the one or more articles. The source search engine is configured to query, using the one or more article identifiers, a source location database to obtain known source locations of the one or more articles of the cargo. The comparison engine configured to compare the known source locations of the one or more articles with the cargo-handling conveyance location parameters. The underwriting engine configured to compute a first premium rate and associate a usage-based cargo insurance policy having the first premium rate with the unique cargo-handling conveyance identifier in a policyholder database in response to the comparison engine finding a match between the cargo-handling conveyance location parameters and a known source location of the one or more articles.

In yet another aspect, the disclosure concerns a computer-implemented method for managing a usage-based insurance policy for a fishing vessel. Actions of the method include pre-registering the fishing vessel by recording a unique fishing vessel identifier and requesting usage-based insurance of the catch in response to collecting, by the fishing vessel, a catch comprising one or more fish species. Usage is requested by transmitting, over a communications network, location parameters of the fishing vessel and one or more fish species. Additionally, the method includes querying, using the one or more fish species, a known range database to obtain known ranges of the one or more fish species; comparing the known ranges of the one or more fish species with the fishing vessel location parameters; and, when a match between the location parameters of the fishing vessel and known ranges of the one or more fish species as is found, computing a first premium rate and associating a usage-based insurance policy having the first premium rate with the unique fishing vessel identifier in a policyholder database.

### BRIEF DESCRIPTION OF THE FIGURES

The summary above, as well as the following detailed description of illustrative embodiments, is better understood when read in conjunction with the appended drawings. For the purpose of illustrating the present disclosure, example constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers. Dashed arrows in flow diagrams imply the preceding may be variable or that a step may or may not follow.

Embodiments of the present disclosure will now be described, by way of example only, with reference to the following diagrams wherein:

FIG. 1 is a high-level schematic illustration of an example policy processing system suitable for practicing embodiments of the present disclosure.

FIG. 2 is a schematic illustration of an example network environment suitable for practicing embodiments of the present disclosure.

FIG. 3 is a flow diagram illustrating example steps of a method for issuing and managing a usage-based insurance policy for a cargo-handling conveyance, in accordance with an embodiment of the present disclosure.

FIG. 4 is a continuation of the flow diagram of FIG. 3.

FIG. 4A is a continuing branch of the flow diagram of FIGS. 3 & 4 as it pertains to the contribution of environmental hostility to insurance policy management.

FIG. 4B is a continuing branch of the flow diagram of FIGS. 3 & 4 as it pertains to the contribution of article collection processes to insurance policy management.

FIG. 4C is a continuing branch of the flow diagram of FIGS. 3 & 4 as it pertains to the contribution of article quantities to insurance policy management.

FIG. 4D is a continuing branch of the flow diagram of FIGS. 3 & 4 as it pertains to the contribution of cargo-handling conveyance equipment lifecycle and maintenance to insurance policy management.

FIG. 5 is a high level flow diagram illustrating example steps for registering equipment components of a cargo-handling conveyance prior to issuance and management of a usage-based insurance policy.

FIG. 6 is a high level flow diagram illustrating example steps of a method for issuing and managing a usage-based insurance policy for a fishing vessel.

FIG. 7 is a schematic illustration of various components of a protection system which may be implemented to manage usage-based insurance policies.

FIG. 8 is a schematic illustration of various components of a policy management system which may be implemented to manage usage-based insurance policies.

### DETAILED DESCRIPTION

Insurance policies typically cover a given vessel with a blanket policy based upon estimated annual cargo or catch volume. As mentioned above, this effectively insures a vessel at one premium rate even during times when cargo is not being transported or when just a small amount of cargo is being transported. The operator of the fishing vessel may benefit from an insurance policy which is usage-based, covering only what needs coverage at any given time.

It is desirable to provide accurate and real-time data about actual cargo transported, vessel location and times when cargo is present on a given vessel. Such improvements would benefit fishing vessel operators and seafood transport managers as well as insurance providers. These benefits, however, extend beyond the fishing and seafood industry to other transportation operations.

The following detailed description illustrates embodiments of the present disclosure and manners by which they may be implemented. Although the best mode of carrying out the present disclosure has been disclosed, those skilled in the art would recognize that other embodiments for carrying out or practicing the present disclosure are also possible.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

Embodiments of the present disclosure provide a computer-implemented method, a computer program product and a system for protecting commodities and other physical, transportable assets by issuing and managing usage-based insurance policies insuring these commodities against damage and/or loss. Actions associated with the computer-implemented method may be performed in response to execution of certain computer-readable instructions by one or more processors or by the processors or processing units employing hardware components to provide policy issuance and management services. Embodiments of the present disclosure substantially eliminate, or at least partially address, problems in the prior art, enabling more reliable prediction of the manner and safety of future operation of cargo-handling services and systems and defending against fraudulent, unregulated and illegal article collection. By the disclosed methods, products and systems, unsustainable and potentially dangerous fishing practices may be reduced.

Additional aspects, advantages, features and objects of the present disclosure will be made apparent from the drawings and the detailed description of the illustrative embodiments construed in conjunction with the appended claims that follow. Further, it will be appreciated that features presently disclosed are susceptible to being combined in various combinations without departing from the scope of the disclosure as defined by the appended claims.

The term commodities, as used herein, may encompass any of a variety of transportable pre- or post-manufacturer goods or assets which move between various locations during progression through a supply chain. Such commodities include but are not limited to, fish or seafood, cattle, poultry, produce, grains, spices, minerals, pharmaceuticals, ores, integrated circuits, computing devices, automobiles and furniture. Any volume of commodity may be quantized into one or more articles. For example, a cargo including a volume of integrated circuits is comprised of a number of individual integrated circuit articles. A cargo including a volume of seafood may be comprised of a number of articles, namely, fish. Individual articles of a cargo are identifiable with individual article identifiers. In the case of integrated circuits, such article identifiers may be a serial number and/or model number or similar which indicates the type of articles represented by the individual articles. With the case of seafood, individual article identifiers may or may not be applied to individual fish. However, each fish will be identified as being of a particular type, namely, species.

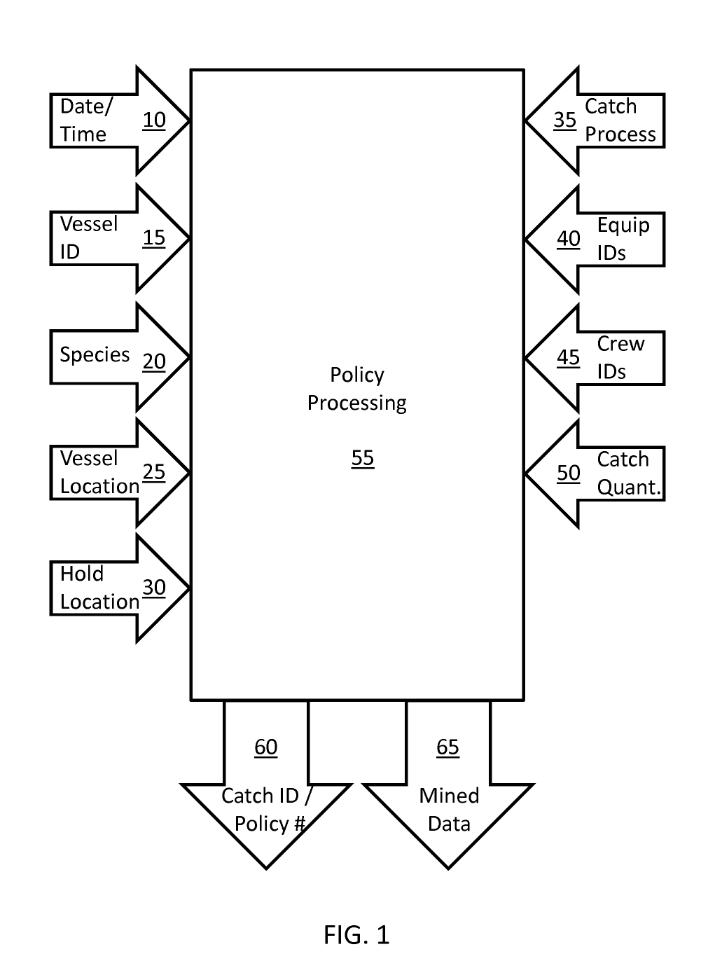

Referring now to the drawings, particularly by their reference numbers, FIG. 1 is a broad, schematic illustration of input and output data flows in an example protection system configured to issue and manage usage-based insurance policies formulated to protect a catch of a commercial fishing vessel. Information regarding the catch to be insured includes but is not limited to date/time 10, fishing vessel identifier 15, species caught 20, vessel location 25, hold location 30, catch method 35, vessel equipment identifiers 40, crew identifiers/registration numbers/certification numbers 45 and catch quantifiers 50. Each of these informational components and others not mentioned here may be provided to a policy processing component 55 during policy application, issuance and management processes.

With information such as the above provided, policy processing component 55 evaluates the information and, in the event the risks represented by the catch and the information related thereto are acceptable, issues a policy 60 to protect the catch against damage and/or loss. In some examples, mined or extracted data 65 such as portions of the information provided and/or metadata 65 associated with the information is output to a third party. This mined or otherwise extracted data or information may be provided to regulatory agencies or statistical modeling services. For example, regulatory agencies and licensing organizations frequently require forms to be completed to apply for the type of license the agency or organization issues. Extracted data 65, including but not limited to vessel identifiers and crew certification numbers may be provided to the requisite forms to facilitate and/or expedite license application processes. Alternatively or additionally, the extracted data or information including but not limited to catch volume, geographic location and timestamps may be stored and analyzed for updating the risks associated with insuring cargo-handling conveyances.

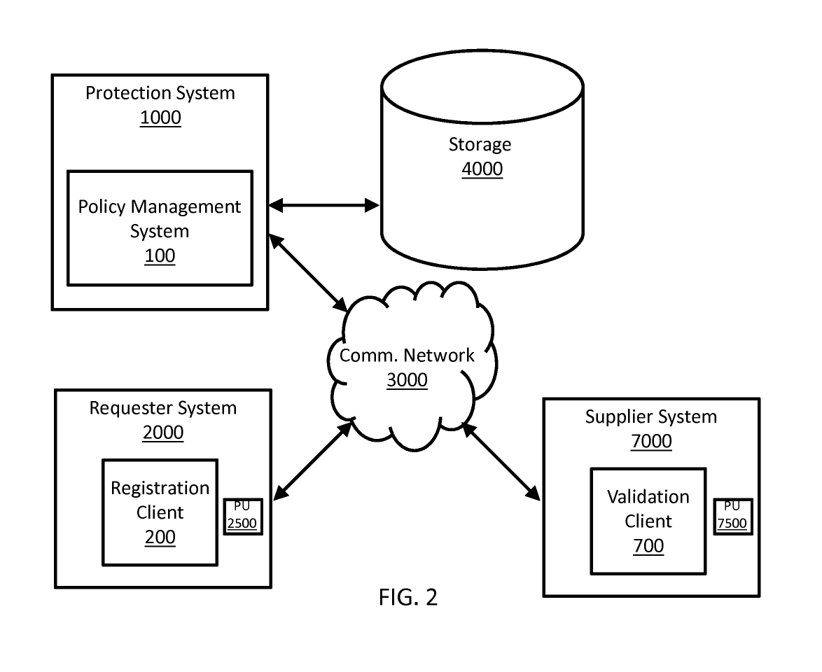

FIG. 2 is a schematic illustration of an example network environment that is suitable for practicing embodiments of the present disclosure. The network environment includes one or more data processing units, for example, a protection system 1000, a requester system 2000 and a supplier system 7000. The network environment of FIG. 2 also includes storage 4000 in communication with protection system 1000 directly or via communication network 3000. In some examples, requester system 2000 and/or supplier system 7000 may also be in communication with storage 4000.

Protection system 1000, employing a policy management system 100, receives data such as, for example, registration data, location data, article identifiers, crew identifiers, collection process data and equipment identifiers from a requester system 2000 employing a registration client 200 for registration and data transmission. When risks derived from the data transmitted by the requester system 2000 are acceptable, policy management system 100 approves or declines protection policies with policy verification transmission to registration client 200. When a policy has been previously established and additional information is received from registration client 2000, policy management system 100 may modify the terms of the previously established policy.

The network environment may be implemented in various ways, depending on various possible scenarios. In one example scenario, the network environment may be implemented by way of a spatially collocated arrangement of protection system 1000, requester system 2000, supplier system 7000 and storage 4000. In another example scenario, the network environment may be implemented by way of a spatially distributed arrangement of protection system 1000, requester system 2000, supplier system 7000 and storage 4000 coupled mutually in communication via the communication network 3000 including but not limited to a cloud computing network.

The communication network 3000 may be a collection of individual networks, interconnected with each other and functioning as a single large network. Such individual networks may be wired, wireless, or a combination thereof. Examples of such individual networks include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, and Worldwide Interoperability for Microwave Access (WiMAX) networks.

Examples of the data processing units for use as protection system 1000, requester system 2000 and supplier system 7000 include, but are not limited to, mobile phones, smart telephones, Mobile Internet Devices (MIDs), tablet computers, Ultra-Mobile Personal Computers (UMPCs), phablet computers, Personal Digital Assistants (PDAs), web pads, Personal Computers (PCs), handheld PCs, laptop computers, desktop computers, Network-Attached Storage (NAS) devices, large-sized touch screens with embedded PCs, and interactive entertainment devices, such as game consoles, Television (TV) sets and Set-Top Boxes (STBs). In some example embodiments, a mobile data processing unit such as a tablet computer or a mobile phone is implemented as requester system 2000 and supplier system 7000 to facilitate remote access from a cargo-handling conveyance to services of protection system 1000. While a mobile device may be employed, a desktop personal computer or a work station may be suitable as protection system 1000 which may remain in a given location.

The network environment is suitable for implementing various systems for issuing and managing usage-based insurance policies. In order to implement a system for issuance and management of usage-based insurance policies, the protection management system 1000 provides a policy issuance and policy management service to requester system 2000, while storage 4000 holds premium determination factors, data related to the usage-based insurance policies and policyholder information. Accordingly, system 1000 may be implemented by way of a hardware product, a software product or a combination of these.

Optionally, requester system 2000 may access protection system 1000 to download one or more software products associated with the policy issuance and management service. In one embodiment, the network environment and systems 1000, 2000 and 7000 are arranged or configured in a manner such that functionality is implemented partly in requester system 2000, partly in supplier system 7000 and partly in protection system 1000.

In such an implementation, requester system 2000 may be coupled to protection system 1000 periodically or randomly from time to time, for example, to upload to protection system 1000 policy updates such as location parameters, collection processes, etc, and/or associated time-stamps and/or to receive software updates and premium updates from protection system 1000. Furthermore, supplier system 7000 may be coupled to protection system 1000 periodically or randomly from time to time, for example, to upload to protection system 1000 reports verifying the authenticity of cargo descriptions transmitted by requester system 2000 to protection system 1000 and/or to receive software updates from protection system 1000.

Users associated with requester system 2000 and supplier systems 7000 use the policy issuance and management services of protection system 1000. Accordingly, requester system 2000 may be used, operated, or carried by cargo managers, while supplier system 7000 may be used, operated, or carried by suppliers or other entities receiving cargo from cargo managers.

Requester system 2000 and supplier system 7000 may further comprise one or more sensors including one or more of: an accelerometer, a magnetometer, a pressure sensor, a temperature sensor, a gyroscopic sensor, a Global Positioning System (GPS) sensor, or a timer. The sensors may be used to measure and collect data related to surroundings of the cargo manager or operator and the cargo handling conveyance they manage or operate.

In some examples, registration client 200 may be interfaced with the sensors such that registration client 200 is configured to resolve and integrate the outputs of the sensors into useful information about cargo or a cargo-handling conveyance to be insured.

In some examples, the sensors may include a GPS sensor for determining one or more absolute spatial positions of the user upon a surface of the Earth.

In some examples, the sensors may include a timer for including time-stamps with data transmitted by requester system 2000 to protection system 1000. Alternatively, processor 2500 of requester system 2000 may provide system time as reference for including the time-stamps with cargo information. Time stamps either from the timer or from processor system time may be used to determine periods of coverage for a cargo so that premiums may be based upon actual usage.

In some examples, sensors of requester system 7000 may include a scanner capable of reading bar codes of either the 1- or 2-dimensional variety which have been applied to articles of the cargo and represent identifiers of the articles of cargo. Scanning bar codes in this way enables expedient verification of the cargo identity.

FIG. 2 is merely an example, which should not unduly limit the scope of the claims herein. It is to be understood that the specific designation for communication network 3000 is provided as an example and is not to be construed as limiting communication network 3000 to specific numbers, types, or arrangements of data processing units, servers, databases and communication networks. A person skilled in the art will recognize many variations, alternatives, and modifications of embodiments of the present disclosure.

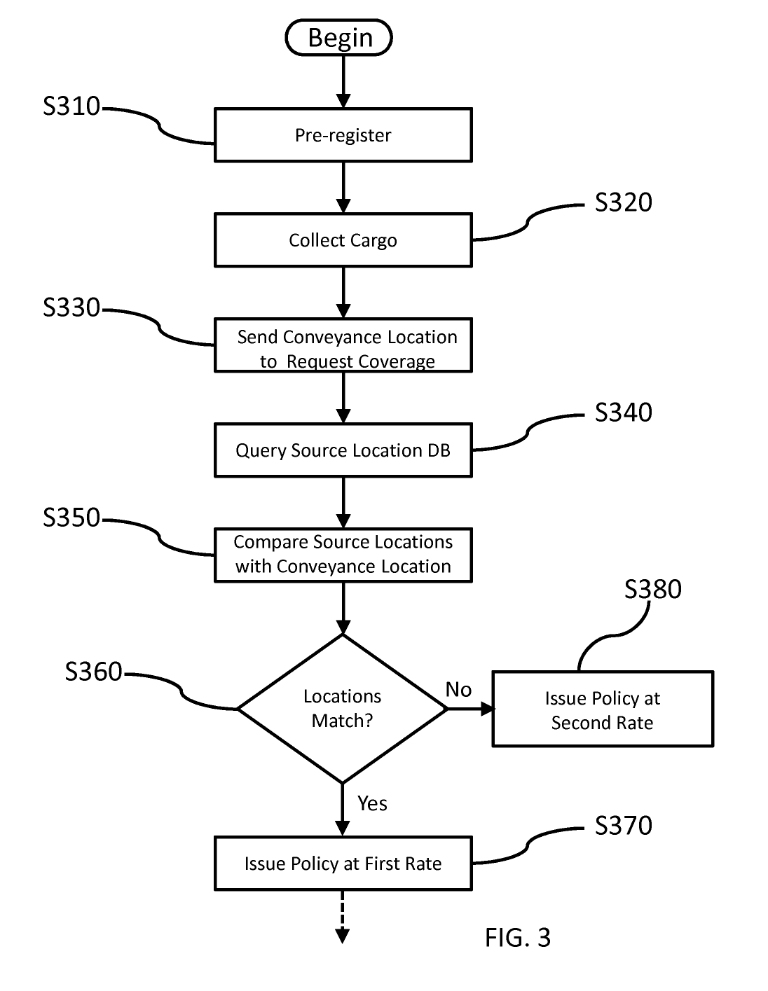

An example method for issuing a usage-based insurance policy for a cargo-handling conveyance and/or its cargo, is illustrated as a flow diagram in FIG. 3. The flow diagram illustrates example steps of a method in accordance with an embodiment of the present disclosure. Steps are implementable by one or more computers or a network of computers like that of FIG. 2 or similar thereto. The method is depicted as a collection of steps or actions in a logical flow diagram, which represents a sequence of steps or actions that may be implemented in hardware, software, or a combination thereof.

A cargo-handling conveyance is pre-registered when protection system 1000 records a unique cargo-handling conveyance identifier in accordance with a step S310. In one implementation, in order to enable pre-registration, the cargo-handling conveyance or a manager or operator thereof will have installed a registration client 200 on requester system 2000 which may be part of the on-board equipment or instruments of the cargo-handling conveyance or may be a mobile device as mentioned above which may be carried or worn by the manager or operator. For example, requester system 2000 may be a tablet, phone or phablet configured for sending and receiving data and other signals over a communications network such as network 3000. The requester system 2000 will be equipped with sensors including a global positioning system (GPS) or other means for determining a location or location parameters of requester system 2000 and registration client 200.

In the event that a cargo-handling conveyance collects cargo comprising one or more articles according to a step S320 and a manager of the cargo-handling conveyance desires to protect the conveyance, the articles of cargo, or both, the manager employs requester system 2000 to transmit, over a communications network 3000 in accordance with a step S330, location parameters of the cargo-handling conveyance and one or more article identifiers representing the one or more articles. Thus, in response to the cargo-handling conveyance collecting cargo, a request for a usage-based insurance policy is selectively sent to protection system 1000. It should be noted that in some embodiments, step S320 is not implemented by any computer. However, in some embodiments pertaining to data packet transport, or information transmission, S320 may indeed be implemented by computer.

Location parameters transmitted during step S330 may include coordinates obtained from a global positioning system of the requester system 2000 or a system operatively coupled thereto or may include any of a variety of information related to the location of the cargo-handling conveyance system and/or requester system 2000. For example, location parameters may include but are not limited to the type of location such as a hatchery, an aqua farm, a port, or a processor location; the name of the location; a location identification number; a water type such as fresh, salt, brackish, etc.; and/or an area type such as a pen, a pond, a bed, etc.

The request for coverage may be initiated by the manager or other cargo-handling conveyance crewmember by, for example, making a selection from a graphical user interface displayed by registration client 200 and providing identifying information of the cargo collected. Identifying information may include a brief description of the articles of the cargo or formally assigned identifiers which may include serial numbers, model numbers, etc. In one example, the articles may include bar codes of either the 1- or 2-dimensional variety that a scanner of the requester system 2000 is capable of reading for direct transmission to protection system 1000 for policy application or registration.

Using the one or more article identifiers, protection system 1000 and, more specifically, policy management system 100 query a source location database held at storage 4000 to obtain known source locations of the one or more articles in accordance with a step S340.

These known source locations are then compared with the cargo-handling conveyance location parameters in accordance with a step S350. In this way it may be determined whether it is likely the requester (vessel manager or operator) or requester system 2000 have identified articles which are not typically found in the region of the cargo-handling conveyance at the time of cargo collection. For example, if a shipping truck is loaded with produce at a location remote from any known organic farm and a request is made for insuring organic produce, it is possible the requester is providing false information. Insurance rates may be impacted by this scenario since replacement costs for organic produce is likely to be higher. In another example, if a shipping vessel is loaded with integrated circuits identified as being from a high-quality manufacturer at a location coincident with or near to known facilities of the high-quality manufacturer it is likely the integrated circuits for which coverage has been requested are legitimate integrated circuits from the high-quality manufacturer.

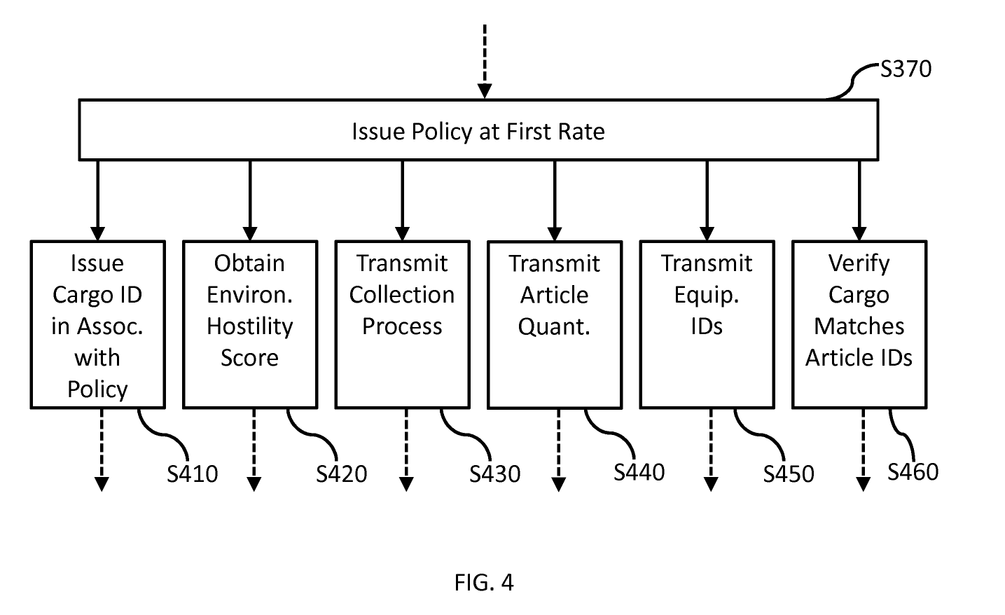

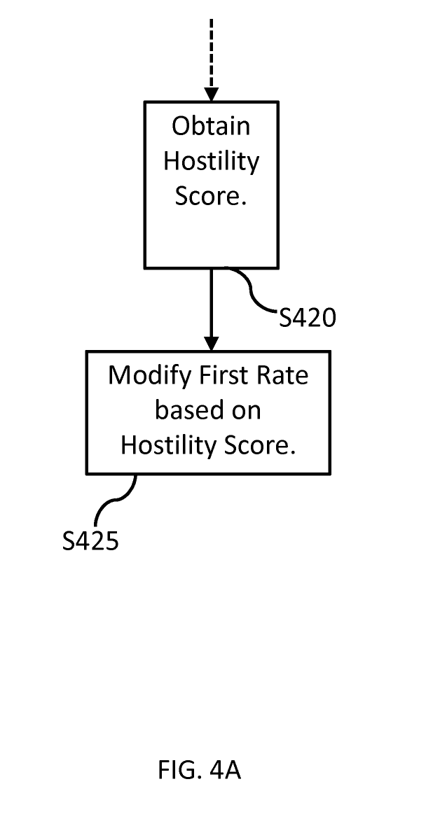

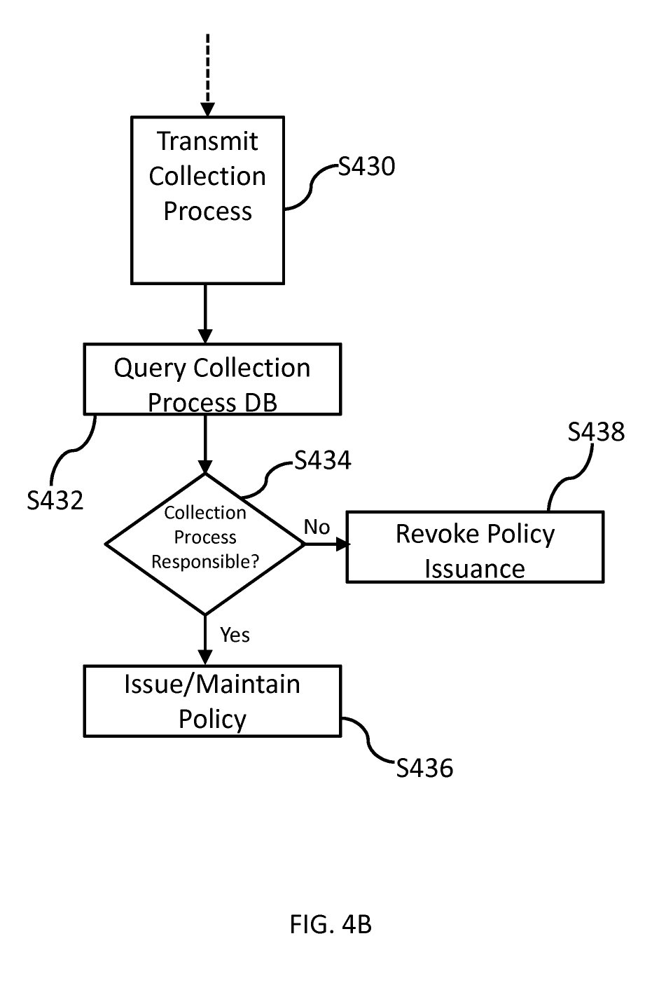

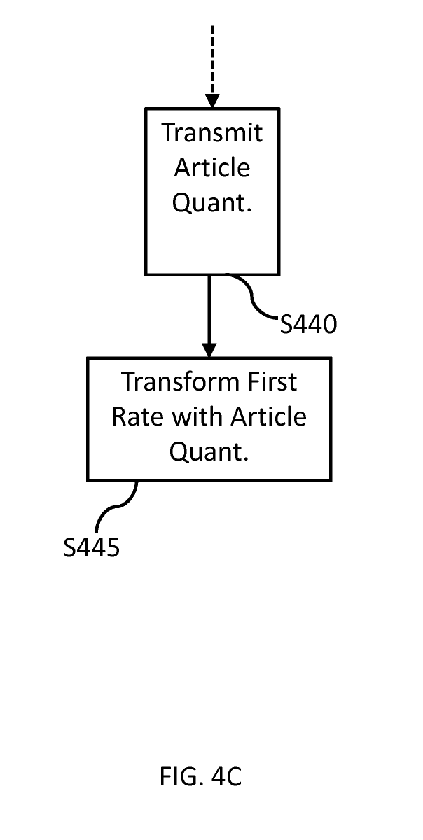

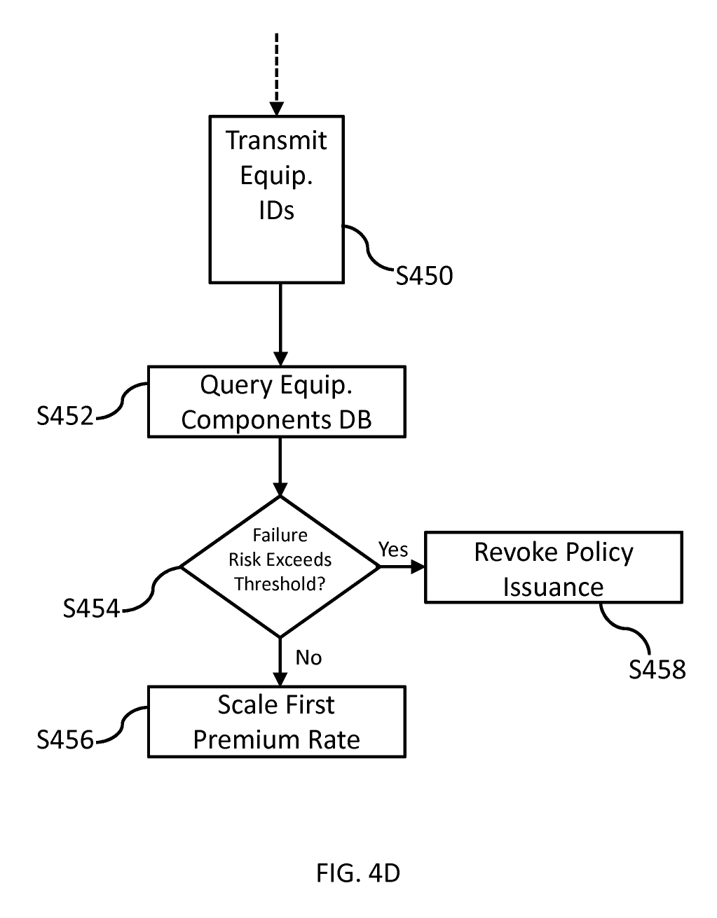

Returning to FIG. 3, in response to finding a match, in a step S360, between the cargo-handling conveyance location parameters and a known source location of the one or more articles as obtained by the querying, the policy management system 100 computes a first premium rate. Furthermore, the unique cargo-handling conveyance identifier is associated with a usage-based cargo insurance policy having the first premium rate in a policyholder database in accordance with a step S370. The policyholder database may be held and maintained at storage 4000 or at a different storage unit. With the policy recorded in association with the unique cargo-handling conveyance identifier, a unique cargo identifier is issued to the cargo in accordance with a step S410 (FIG. 4). This unique cargo identifier is also associated with the policy in the policyholder database and may be used as the policy number. A notification confirming coverage is then sent to the requester at requester system 2000. The unique cargo identifier may later be used by protection system 1000, requester system 2000 and/or supplier system 7000 to trace the cargo or portions thereof through various processes required to yield an end product from the articles of the cargo.

In response to finding no match, in a step S360, between the cargo-handling conveyance location parameters and a known source location of the one or more articles as returned by the querying, the policy management system may compute a second premium rate different from the first premium rate. A usage-based cargo insurance policy having the second premium rate is associated with the unique cargo-handling conveyance identifier in the policyholder database in accordance with a step S380. Again, a unique cargo identifier may be issued to the cargo and used as a policy number. Coverage is confirmed to the requester.

In another example, rather than issuing a cargo insurance policy at a second premium rate during a step S380, the protection system 1000 and policy management system 100 may be configured to decline issuance of a policy and generate an “insurance declined” notice when no match is found between the conveyance location and the known source locations of the cargo. In such case, no unique cargo identifier is issued.

Any of a number of actions may be taken after associating the unique cargo-handling conveyance identifier with a usage-based cargo insurance policy having either of the first or second rates in a policyholder database. For example, a unique cargo identifier may be issued in association with the policy in accordance with a step S410 or actions may be performed to adjust the first premium rate. FIG. 4 is a continuation of the flow diagram of FIG. 3 and illustrates a number of actions which may be taken after a policy is issued at a first rate, a second rate or any other rate derived from collected risk factors.

In an example of an adjustment action, policy management system 100 queries, using the received cargo-handling conveyance location parameters, an environmental hostility score database to obtain an environmental hostility score corresponding to the cargo-handling conveyance location parameters in accordance with a step S420. FIG. 4A is a continuing branch of the flow diagram of FIGS. 3 & 4 as it pertains to the contribution of environmental hostility to insurance policy management. The established premium rate may be modified in a step S425 with the environmental hostility score returned by the querying. In some configurations, if the hostility score exceeds a threshold level, the insurance policy may be cancelled or declined and the usage-based cargo insurance policy disassociated from the unique cargo-handling conveyance identifier.

In another example of adjustment action, a collection process proclaimed by a shipping vessel operator for the one or more articles may also be transmitted over communications network 3000 from registration client 200 to policy management system 100 in accordance with a step S430. FIG. 4B is a continuing branch of the flow diagram of FIGS. 3 & 4 as it pertains to the contribution of article collection processes to insurance policy management. After receiving the proclaimed collection process, policy management system 100 then queries, using the transmitted proclaimed collection process for the one or more articles, a responsible collection process database held at storage 4000 to obtain one or more responsible collection processes corresponding to the one or more articles in accordance with a step S432. The proclaimed collection process for the one or more articles is then compared by policy management system 100 with the one or more responsible collection processes in accordance with a step S434.

When the proclaimed collection process of the one or more articles matches a responsible collection process as returned by the querying using the proclaimed collection process, the policy may be unaffected or otherwise maintained in the state of original issuance in accordance with a step S436. In some examples, incentives such as a reduced premium may be offered to a requester when a particular collection process is employed. For example, some collection processes may take greater precautions against damaging the articles or against incidental damage to facilities, sites or other articles at the collection site that were not collected. Some fishing processes may be less likely to produce bi-catch or species other than the target species.

In response to finding no match between the proclaimed collection process of the one or more articles and a responsible collection process as returned by the querying, the usage-based insurance policy may be revoked and the unique cargo-handling conveyance identifier disassociated from the usage-based insurance policy in the policyholder database in accordance with a step S438. In some examples, rather than revoking the policy, the policy may be associated with a premium rate higher than the first rate when the proclaimed collection process is not matched with a responsible collection process.

In some instances, the requester may attempt to transmit a collection process inconsistent with the capabilities recorded with the cargo-handling conveyance and associated with the unique cargo-handling conveyance identifier. For example, a fishing vessel captain may choose “long line” as the collection process for a catch while the vessel is registered only for “gill net” or “seiner.” In this case, the conflicting collection process will cause protection system to decline or cancel a usage-based insurance policy or will reject the input of “long line” and send notification to requester system 2000 that the collection process selected is in conflict with registered data concerning the fishing vessel.

Additionally, the requester system may transmit one or more cargo quantifiers of the cargo over communications network 3000 in accordance with a step S440. FIG. 4C is a continuing branch of the flow diagram of FIGS. 3 & 4 as it pertains to the contribution of article quantities to insurance policy management. After receiving one or more cargo quantifiers, policy management system 100 may then transform the first premium rate with the one or more cargo quantifiers in accordance with a step S445. For example, cargo comprising two hundred articles may be assigned a premium rate twice that of cargo comprising one hundred articles. Quantification of cargo may be accomplished in any of a variety of manners including counting a number of articles of cargo or weighing the cargo. In some examples, a premium rate for a massive cargo or a large number of articles may be entitled to a bulk rate discount.

Cargo-handling conveyances carry various equipment components provided to enable operation of the conveyance. In circumstances wherein these equipment components are missing or not properly functioning, cargo handling may be adversely affected and timely delivery of cargo may not be possible thus costing the conveyance operator or a cargo-receiving station resources. This, in turn, increases risks to an insurer protecting the cargo in a usage-based or other insurance policy type.

To account for equipment conditions during policy management, registration client 200, at the request of the conveyance operator or manager, transmits identifiers of one or more equipment components of the cargo-handling conveyance to the policy management system 100 over communications network 3000 in accordance with a step S450. FIG. 4D is a continuing branch of the flow diagram of FIGS. 3 & 4 as it pertains to the contribution of cargo-handling conveyance equipment lifecycle and maintenance to insurance policy management.

Having received the one or more equipment component identifiers, protection system 1000 may then query an equipment components database held at storage 4000 using the identifiers of the one or more equipment components to obtain failure risks associated with the one or more equipment identifiers and/or the one or more equipment components associated therewith in accordance with a step S452.

The failure risks are then compared with a failure risk threshold in accordance with a step S454. In response to discovering the threshold is greater than the failure risks, protection system 1000 scales the first premium rate in accordance with the failure risks in accordance with a step S456. In response to discovering the failure risks exceed the threshold, protection system 1000 revokes the usage-based insurance policy and disassociates the unique cargo-handling conveyance identifier from the usage-based insurance policy in the policyholder database in accordance with a step S458. In some cases, the condition of equipment on board the cargo-handling conveyance may be assessed before policy issuance such that when the risks exceed the threshold, no policy is ever issued.

The failure risks associated with the one or more equipment identifiers or one or more equipment components correlated thereto may be established from any of a number of factors including but not limited to a number of hours of actual operation and a known lifetime of the one more equipment components. For example, if an engine of the cargo-handling conveyance has a operational lifetime of 100,000 hours and the protection system discovers that 95,000 hours have been recorded with the engine, the first premium rate may be scaled to 110% whereas if the engine has been operated for 105,000 hours, the usage-based insurance policy may be revoked and disassociated from the unique cargo-handling identifier or, in the event that equipment risks are evaluated prior to policy issuance, may never be issued.

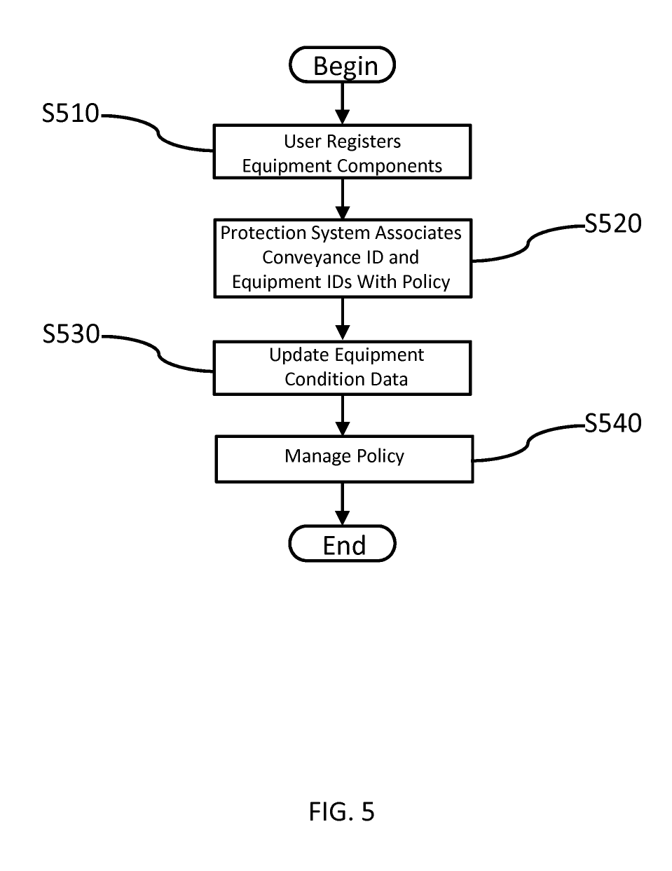

FIG. 5 is a high level flow diagram illustrating example steps for registering equipment components of a cargo-handling conveyance to account for equipment condition during issuance and management of a usage-based insurance policy.

In an example policy management method, equipment accounting begins when a cargo-handling conveyance is equipped i and a user registers equipment components in accordance with a step S510 during which protection system 1000 receives registration information regarding the equipment components. Protection system 1000 then associates a cargo-handling conveyance identifier and equipment component identifiers with a protection or insurance policy according to a step S520. Equipment condition data is updated in an equipment condition database based upon operating hours and conditions in accordance with a step S530. As the equipment is used and ages, the protection or insurance policy is updated to reflect the condition of the equipment according to a step S540. The equipment condition database may also be held in storage 4000 or in another storage unit.

Upon delivery of the one or more articles to a receiving entity after transport, it may be verified that the one or more article identifiers accurately represent the cargo in accordance with a step S460. In an example, the receiving entity may employ, contain or comprise a supplier system 7000 in the form of mobile computing device configured to transmit a verification notice to protection system 1000, requester system 2000 or both. For example, a camera may be used to record the appearance of the cargo or a camera or scanner may be used to scan or otherwise capture a bar code or other means for uniquely identifying articles or the cargo. The unique cargo identifier may also be transmitted by the supplier, wholesaler or other receiving party to protection system 1000 and/or requester system 2000. In some examples, the bill of lading may only be acknowledged as clean once the cargo has been verified as described by the cargo conveyance operator.

It should be noted that any or all of the steps S410, S420, S430, S440, S450 and S460 may be performed before, during or after issuance of a policy at the first premium rate, second premium rate or other premium rate. Furthermore, these steps may be performed simultaneously or at different times. Some of steps S410, S420, S430, S440, S450 and S460 may be performed before issuance of a policy at a given rate while others may be performed after issuance of such a policy in order to maintain the policy.

As with the aforementioned equipment components, one or more operator parties may also be associated with the cargo-handling conveyance such as by the unique cargo-handling conveyance identifier. For example, a master mariner or captain, a chief engineer, a mate or navigator and/or a marine biologist observer may be registered as a parties contributing to the safe and sustainable operation of a fishing vessel identified by a unique fishing vessel identifier. Each of these parties may have their own registration with a regulatory body which may employ a registration number with which characteristics of the parties may be associated. Characteristics of the parties may include scores reflecting the operational history of the parties and the degree to which they have been known to comply with rules and/or regulations related to safe and sustainable fishing vessel operation. Characteristics of these responsible parties may be taken into account during policy issuance and/or management.

Policy issuance and management services as disclosed herein can be offered free of cost or as a paid service that has a subscription-based billing or a transaction-based billing, such as pay-per-use and pay-per-feature. Requesters and/or policyholders and/or insurance providers may be charged directly for the services or one of these parties may be charged directly and pass the costs onto one or more of the remaining parties.

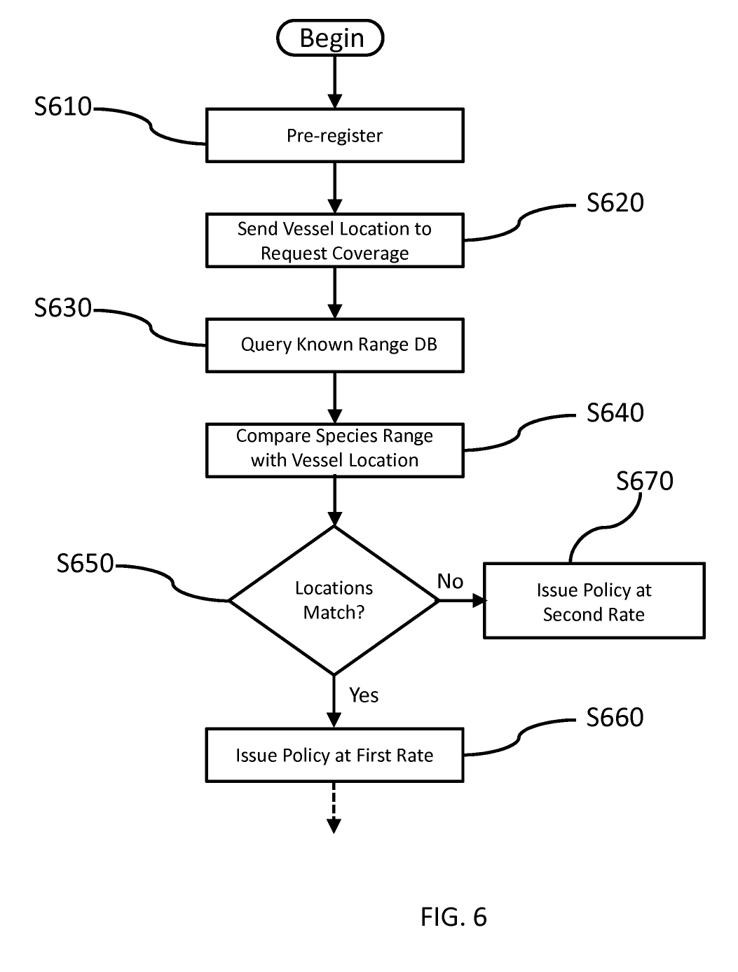

FIG. 6 is a flow diagram illustrating example steps of a method for issuing a usage-based insurance policy for a fishing vessel needing to transport a catch, in accordance with an embodiment of the present disclosure. According to a step S610, a fishing vessel is pre-registered by recording a unique fishing vessel identifier. This fishing vessel identifier may for example, be an identifier issued by the International Marine Organization or other certifying body. After pre-registration, in response the fishing vessel collecting a catch comprising one or more fish species, a manager, operator, captain or other party contributing to the operation or management of the vessel requests usage-based insurance of the catch by transmitting, over a communications network such as 3000, location parameters of the fishing vessel and one or more fish species in accordance with a step S620.

With the location parameters and the fish species names, protection system 1000 employs the one or more fish species names to query a known range database to obtain known ranges of the one or more fish species in accordance with a step S630. If, upon comparison of the known ranges of the one or more fish species with the fishing vessel location parameters in accordance with a step S640, the location parameters of the fishing vessel match known ranges of the one or more fish species as represented by a step S650, protection system 1000 computes a first premium rate and associates a usage-based insurance policy having the first premium rate with the unique fishing vessel identifier in a policyholder database in accordance with a step S660.

In response to finding no match between the fishing vessel location parameters and a known range of the one or more fish species as returned by the querying, protection system 1000 may compute a second premium rate different from the first premium rate and associate a usage-based insurance policy having the second premium rate with the unique fishing vessel identifier in the policyholder database in accordance with a step S670 or may decline issuance of a policy altogether.

With this functionality it is possible for an insurance provider to determine a probability that the vessel is indeed carrying the species for which coverage has been requested, enabling fraud reduction. Furthermore, the location parameters may imply the vessel has captured a particular species from a region in which fishing of that species is unsustainable or prohibited. Thus, good fishing practices may be encouraged or incentivized and bad fishing practices may be discouraged or dis-incentivized through premium tailoring and/or other insurance protocol.

Similar to the general method, in the particular method for issuing a usage-based insurance policy to a fishing vessel, a unique catch identifier may be issued for the catch and this catch identifier may, in turn, be associated with the usage-based insurance policy in the policyholder database.

The conditions in the region of the fishing vessel may also be evaluated for known hostility. For example, if the waters are known to be turbulent, if there is a stormy weather forecast or if pirates are known to be active in the region, an insurance provider implementing the protection system 1000 may desire to modify the premium rate. Protection system 1000 may use the fishing vessel location parameters to query an environmental hostility score database to obtain an environmental hostility score for the fishing vessel location parameters. The hostility score returned by the querying may then be used to modify the first premium rate or other premium rate to reflect the level of risk taken by the insurance provider in insuring the vessel, the catch or both given the known environmental hostility or hostilities.

An insurance provider interested in insuring a catch of a fishing vessel may also prefer to adjust the rate of the premium based upon the size of the catch. One or more catch quantifiers may also be transmitted by requester system 2000 over the communications network to protection system 1000. With the one or more catch quantifiers, protection system 1000 may then transform the first premium rate. For example, if the catch is to be insured as ten tons of herring, the premium is likely to be greater than if the catch is to be insured for just eight tons of herring. As described above with respect to the generic usage-based policy management method, quantifiers may be established with a count, a weight or a combination of these.

As another approach to encouraging good fishing practices, an insurance provider may evaluate the fishing techniques used by a fishing vessel. Requester system 2000 may also transmit, to protection system 1000 over communications network 3000, a proclaimed collection process for the fish species. Using the proclaimed collection process for the one or more fish species, protection system 1000 may query a responsible collection process database to obtain one or more responsible collection processes for the species name transmitted by a vessel captain or other manager using the requester system 2000.

Upon comparing the proclaimed collection process for the one or more fish species with the one or more responsible collection processes and finding no match, protection system 1000 may revoke the usage-based insurance policy and disassociate the unique fishing vessel identifier from the usage-based insurance policy in the policyholder database. Alternatively, a usage-based insurance policy may be issued at a second, higher premium rate or the first premium rate may be updated when the proclaimed collection process does not match known responsible collection processes. When the evaluation of the fishing techniques or collection process is completed before issuance of a usage-based insurance policy and no match is found between the process used and the one or more responsible collection processes protection system 1000 may decline coverage.

When the proclaimed collection process matches one or more known responsible collection processes for the species name, a usage-based insurance policy may be issued, or if already issued, may be maintained without adjustment.

Additionally, as with the generic method outlined previously, risks to an insurer protecting a fishing vessel catch in a usage-based insurance policy or other policy type are increased if the equipment components provided to enable operation of the vessel are missing or not properly functioning. For example, if no fire extinguishers are present on the vessel, both the catch and the vessel are more likely to experience damage or a loss in the event of a fire. In another example, if a drive belt of a driving motor of the vessel has accrued more than the typical number of lifetime hours of operation, the vessel is more likely to break down during transport causing a loss of the catch.

By transmitting, over the communications network, identifiers of one or more equipment components of the fishing vessel using requester system 2000 and querying, using the identifiers, an equipment components database to obtain failure risks associated with the one or more equipment components, protection system 1000 may compare the failure risks with a failure risk threshold.

When protection system 1000 discovers the threshold is greater than the failure risks the first premium rate is scaled in accordance with the failure risks.

When protection system 1000 discovers the failure risks exceed the threshold and a policy has already been issued, the usage-based insurance policy may be revoked and the unique fishing vessel identifier may be disassociated from the usage-based insurance policy in the policyholder database. However, if no policy has yet been issued, protection system 1000 may simply decline issuance of a policy.

Again, failure risks associated with the one or more equipment components may be established according to any of a variety of factors including but not limited to a number of hours of actual operation relative to a known lifetime of the one more equipment components or the manufacturer name for the equipment component.

Upon delivery of the catch to a supplier, wholesaler or other receiving entity, verification may be undertaken to ensure that the one or more fish species transmitted by the vessel manager or operator accurately represent the catch. If the verification process concludes that the transmitted species names do not accurately represent the catch, this information may be transmitted to protection system 1000 for storage for use in later evaluation of policies for the vessel manager or operator who provided false information regarding the cargo.

In an alternative, verification may be undertaken by a marine biologist or other third part observer at the time of collection of the catch. For example, the marine biologist may use a genome test or visual inspection to confirm the identity of the species.

The steps depicted in each of FIGS. 3-6 are only illustrative and other alternatives can also be provided where one or more steps are added, one or more steps are removed, or one or more steps are provided in a different sequence without departing from the scope of the claims herein.

The disclosed method of issuing a usage-based insurance policy for a catch of a fishing vessel may be performed by a system comprised of hardware and software or by one or more computers performing instructions residing on a non-transitory computer-readable storage medium and executed by a processor.

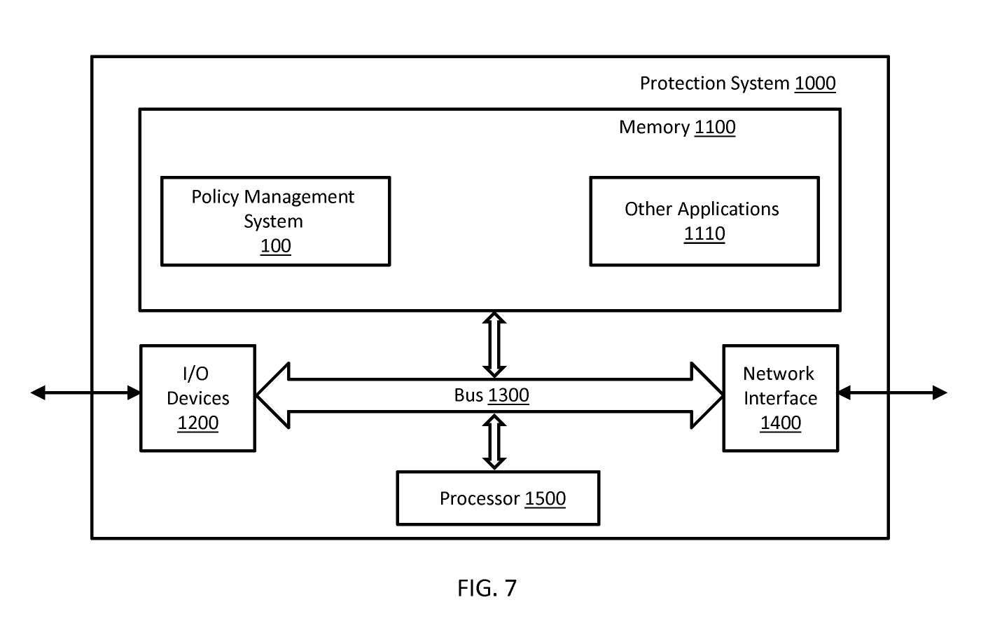

FIGS. 7 & 8 depict, at second and third levels of detail above the level depicted in FIG. 2, various components of protection system 1000 and policy management system 100 which may be cooperatively implemented to manage usage-based insurance policies as described with reference to steps or actions of FIGS. 3-6. The systems and computer program products disclosed may be arranged, configured, or formulated by an insurance provider, an insurance requester a third-party service provider or combinations of these to perform the method of issuing an usage-based insurance policy for a fishing vessel catch. Furthermore, the systems and computer program products may also be arranged, configured or formulated to address other transportation industries and other cargos as mentioned above.

Protection system 1000 which is formulated to issue a usage-based insurance policy for a cargo-handling conveyance, its cargo or both includes, but is not limited to, a memory component 1100, a computing hardware such as a processor 1500, Input/Output (I/O) devices 1200, a network interface 1400, and a system bus 1300 that operatively couples various components including memory component 1100, processor 1500, I/O devices 1200, and network interface 1400. I/O devices 1200 may include a display screen for presenting graphical images to a user of protection system 1000.

Protection system 1000 also includes a power source for supplying electrical power to the various components thereof. The power source may, include, for example, a rechargeable battery.

In some examples, the display screen may be a touch-sensitive display screen that is operable to receive tactile inputs from the user. These tactile inputs may, for example, include clicking, tapping, pointing, moving, pressing and/or swiping with a finger or a touch-sensitive object like a pen.

Additionally or alternatively, the I/O devices 1200 include a mouse or a joystick that is operable to receive inputs corresponding to clicking, pointing, and/or moving a pointer object on the graphical user interface. The I/O devices 1200 may also include a keyboard that is operable to receive inputs corresponding to pushing certain buttons on the keyboard. Additionally, the I/O devices 1200 may also include a microphone for receiving an audio input from the user, and a speaker for providing an audio output to the user.

Memory component 1100 optionally includes non-removable memory, removable memory, or a combination thereof. The non-removable memory, for example, includes Random-Access Memory (RAM), Read-Only Memory (ROM), flash memory, or a hard drive. The removable memory, for example, includes flash memory cards, memory sticks, or smart cards.

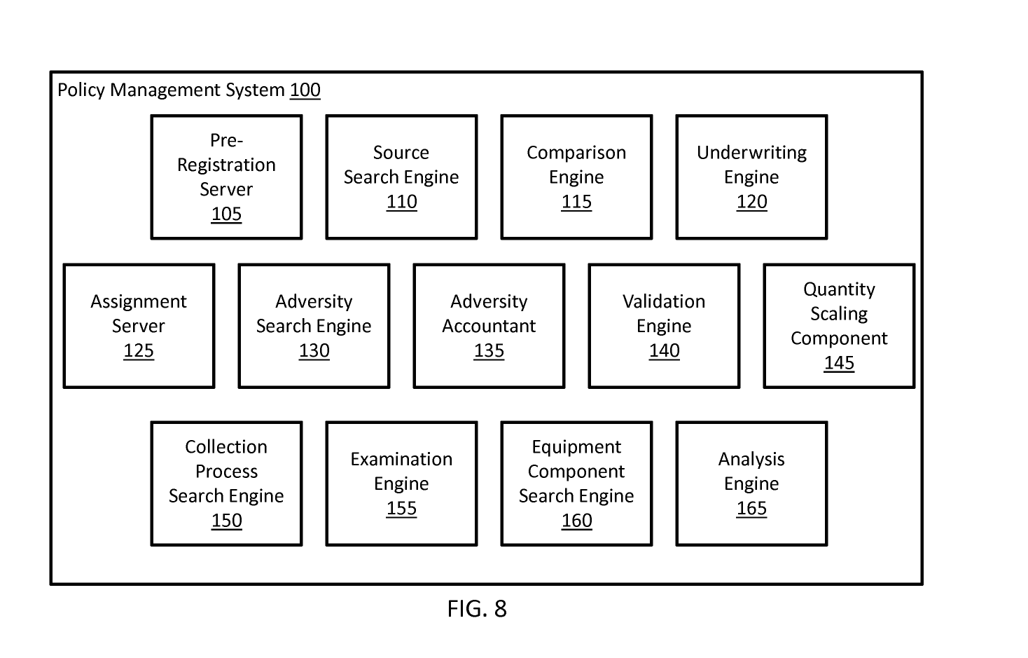

Referring to FIG. 8, memory component 1100 stores policy management system 100 which comprises a pre-registration sever 105, a source search engine 110, a comparison engine 115, an underwriting engine 120, an assignment server 125, an adversity search engine 130, an adversity accountant 135, a validation engine 140, a quantity scaling component 145, a collection process search engine 150, an examination engine 155, an equipment component search engine 160 and an analysis engine 165.

Pre-registration sever 105, source search engine 110, comparison engine 115, underwriting engine 120, assignment server 125, adversity search engine 130, adversity accountant 135, validation engine 140, quantity scaling component 145, collection process search engine 150, examination engine 155, equipment component search engine 160 and analysis engine 165 may, for example, be parts of a computer program product associated with policy management system 100 provided by protection system 1000, may be hardware subcomponents of memory component 1100 or may be a combination of hardware and computer program product. Memory component 1100 may include one or more other applications 1110 employable to provide other services to a user of protection system 1000.

Memory component 1100 as well as storage 4000 are non-transient data storage mediums. The policy management system 100, when executed by processor 1500 is optionally coupled to storage 4000 and is configured to substantially continuously record and update data such as article identifiers, cargo identifiers, known source locations, responsible collection processes, equipment component identifiers, etc. in storage 4000.

Furthermore, network interface 1400 allows protection system 1000 to transmit policy verification, cargo identifiers, etc. to requester system 2000 and supplier system 7000, for example, over communication network 3000. Additionally, network interface 1400 may allow protection system 1000 to access communications network 3000 to update computer program products and/or download one or more new computer program products associated with policy management system 100.

Network interface 1400 may additionally allow protection system 1000 to communicate with other data processing units over communication network 3000.

As mentioned above, protection system 1000 is optionally implemented by any of a variety of computing devices including but not limited to a PC, a laptop computer, a desktop computer or a large-sized touch screen with an embedded PC.

Again referring to FIG. 8, various components of a policy management system 100 which may be implemented by a protection system 1000 to manage usage-based insurance policies in accordance with methods disclosed herein will now be described.

Pre-registration server 105 pre-registers a cargo-handling conveyance by recording a unique cargo-handling conveyance identifier.

When a registration component such as registration client 200 transmits location parameters of a cargo-handling conveyance and one or more article identifiers representing articles of a cargo, source search engine 110 queries a source location database held by storage 4000, using the one or more article identifiers. By querying, source search engine 110 obtains known source locations of the one or more articles of the cargo and provides or otherwise makes available known source locations to comparison engine 115.

Comparison engine 115 compares the known source locations of the one or more articles with the cargo-handling conveyance location parameters and when a match is established, a notification of a location match is provided to underwriting engine 120. When no match is established, a notification of no location match may be provided to underwriting engine 120.

With a notification of matching locations, underwriting engine 120 computes a first premium rate and associates a usage-based cargo insurance policy having the first premium rate with the unique cargo-handling conveyance identifier in a policyholder database.

When a notification of no matching locations is provided by comparison engine 115, underwriting engine 120 computes a second premium rate different from the first premium rate and associates a usage-based cargo insurance policy having the second premium rate with the unique cargo-handling conveyance identifier in the policyholder database. Alternatively, as mentioned above, in some cases no policy will be issued if location parameters do not match with one or more known source locations of the articles of cargo.

Once a usage-based cargo insurance policy has been issued and associated with a premium rate in the policyholder database, usage-based policy assignment server 125 issues a unique cargo identifier for the cargo and associates the unique cargo identifier with the usage-based cargo insurance policy in the policyholder database. This unique cargo identifier may be traced through later stages of the lifecycle of the articles comprising the cargo. For example, if a supplier purchases two tons of a cargo of peanuts and processes one ton as peanut butter but prepares the remaining ton as dry-roasted and salted, the cargo identifier will be associated with both end products. In the event that a contamination or other imperfection of the end product is discovered, it may be traced back to the source cargo and cargo-handling conveyance using the unique cargo identifier.

Furthermore, the unique cargo identifier may be associated with multiple wholesalers, suppliers or resellers. For example, if three different suppliers purchase portions of the cargo of peanuts, the unique cargo identifier will be passed to each of them and will follow the peanuts through any subsequent processing into end user products.

At any of a variety of points in a process of managing a cargo-based insurance policy, an adversity search engine 130 queries, using the location parameters of the cargo-handling conveyance, an environmental hostility score database to return an environmental hostility score for the location parameters. Adversity accountant 135, modifies the first premium rate, or other rate at which a policy has issued, with the environmental hostility score returned by adversity search engine 130. As with other components of management system 100, adversity accountant 135 may modify the first premium rate before or after policy issuance or may prevent issuance of a policy altogether.

As described above, a validation engine 140, upon delivery of the cargo to a receiving entity, verifies that the one or more article identifiers accurately represent the cargo.

During policy management, registration client 200 also transmits one or more cargo quantifiers over communications network 3000. The cargo quantifiers are passed to a quantity scaling component 145 which transforms the first premium rate with the one or more cargo quantifiers. In rare circumstances, an insurance policy may be declined if the cargo quantifier is too large. For example, the insurance provider may not have the resources available to cover the risk of insuring a large cargo in addition to cargos of many other cargo-handling conveyances.

During policy management, registration client 200 also transmits, over the communications network 3000, a proclaimed collection process for the cargo. With the proclaimed collection process for the cargo provided by the registration client 200, collection process search engine 150 queries, using the proclaimed collection process for the cargo, a responsible collection process database to obtain one or more responsible collection processes. The responsible collection process database, as mentioned, may be held at storage 4000. Examination engine 155 compares the proclaimed collection process for the cargo with the one or more obtained responsible collection processes.

When the examination engine obtains no match between the proclaimed collection process of the cargo and a responsible collection process, underwriting engine 120 may revoke the usage-based insurance policy and disassociate the unique cargo-handling conveyance identifier from the usage-based insurance policy in the policyholder database. Again, in circumstances where examination engine 155 obtains no match between the proclaimed cargo collection process and a responsible collection process before policy issuance, underwriting engine 120 may altogether decline a policy rather than needing to revoke the policy. When a match has been obtained from the responsible collection process database, a policy may be issued or any previously issued policy may be maintained or reconfirmed.

During policy management, registration client 200 also transmits, over the communications network 3000, identifiers of one or more equipment components of the cargo-handling conveyance. Using the identifiers of the one or more equipment components, equipment component search engine 160 queries an equipment components database held at storage 4000 to obtain failure risks associated with the one or more equipment components. Analysis engine 165 then compares the failure risks with a failure risk threshold.

When analysis engine 165 discovers that the failure risks exceed the failure risk threshold and provides a corresponding notification to underwriting engine 120, underwriting engine 120 revokes the usage-based insurance policy and disassociates the unique cargo-handling conveyance identifier from the usage-based insurance policy in the policyholder database. Again, if no policy has been issued prior to evaluating the equipment failure risks, underwriting engine 120 may simply decline policy issuance rather than revoking an issued policy.

In an alternative example, underwriting engine 120 may also be configured, arranged or formulated to scale the first premium rate in accordance with the failure risks in response to discovery by analysis engine 165 that the threshold is greater than the failure risks.

As described above, the failure risks associated with the one or more equipment components are established from a number of hours of actual operation and a known lifetime of the one more equipment components.

As discussed, embodiments of the present disclosure provide a computer program product that includes a non-transitory or non-transient computer-readable storage medium storing computer-executable code for issuing a usage-based insurance policy. The code, when executed, is configured to perform the actions of the methods as described in conjunction with FIGS. 3-6. As steps of the disclosed methods may be provided in different sequences, so the computer-executable code may be configured to provide a service having a different sequence of actions from those illustrated as examples in the Figures. In some examples, the code may be downloaded from a software application store, for example, from an “App store”, to a data processing unit such as protection system 1000, requester system 2000 and/or supplier system 7000.

Executing computer program product on processor 1500 results in generating and rendering a graphical user interface on a display screen. The graphical user interface is configured to facilitate user interactions with policy management system 100 and protection system 1000.

Executing computer program product on processor 2500 results in generating and rendering a graphical user interface on a display screen. The graphical user interface is configured to facilitate user interactions with registration client 200, requester system 2000, policy management system 100 and protection system 1000.

In an example, a settings screen output to a display of requester system 2000 may invite the user to select the type of operation with which the cargo-handling conveyance is concerned. For example, the user may choose an icon representative of one or more of the agriculture, automotive, forestry, healthcare, manufacturing, maritime, home service repair or wellness industries.

Selection of an icon representing a particular industry may cause presentation of a number of additional icons to the display, which icons represent further details of the cargo-handling conveyance or other factors associated with the industry concerned. For example, if the user selected the ‘Maritime’ icon, the next series of icons may allow the user to select and register a facet of the maritime industry including but not limited to a vessel and it's type, name, identifier, classification; a participating party and their registration or certification numbers; a vessel location and/or the name and location of a operations manager.

The cargo conveyance manager or operator may be presented with a menu of article identifiers, collection processes, cargo quantifiers, etc., for example, on a display screen of requester system 2000. The cargo manager may select a proclaimed collection process from the menu, and article identifiers, collection process, cargo quantifiers, etc. are transmitted to protection system 1000 for evaluation.

In addition to the settings screen or menu, a user may choose to interact with a ‘Pro Screen’ presenting a number of icons or buttons enabling editing of crew; viewing of vessel information including maintenance history; creation of a trace ID or catch identifier which additionally refers to a catch method, a confirmed location, a species, a vessel hold in which the catch is held and a weight of the catch. Furthermore, the ‘Pro Screen’ may present icons or buttons enabling the user to add or update media associated with the catch including but not limited to video footage or a photo.

Executing computer program product on processor 7500 results in generating and rendering a graphical user interface on a display screen. The graphical user interface is configured to facilitate user interactions with validation client 700, supplier system 7000, policy management system 100 and protection system 1000.

The supplier may be presented with a menu of cargo identifiers, article identifiers, and product identifiers, for example, as icons or buttons on a display screen of supplier system 7000. The supplier may select article identifiers from the menu for transmission to protection system 1000 to confirm article identifiers transmitted by the cargo manager, indeed, represent the cargo insured on behalf of the cargo conveyance manager or operator.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for transporting cargo in accordance with a usage-based insurance policy for a cargo-handling conveyance, comprising:
recording a unique cargo-handling conveyance identifier for the cargo-handling conveyance;
collecting by the cargo-handling conveyance a cargo comprising one or more articles;
obtaining, by a Global Positioning System sensor on the cargo-handling conveyance, location parameters of the cargo-handling conveyance;
obtaining, by scanning one or more barcodes representing the one or more articles, one or more article identifiers representing the one or more articles;
requesting usage-based insurance of the cargo by transmitting, over a communications network, the location parameters and the one or more article identifiers;
obtaining known source locations of the one or more articles from a source location database;
obtaining an environmental hostility score for the location parameters;
determining whether the known source locations match the location parameters;
in response to determining that a match exists between the location parameters and a known source location,
associating the cargo-handling conveyance identifier with a usage-based cargo insurance policy having a first premium rate, wherein the first premium rate is based at least in part on the environmental hostility score, and
storing the first premium rate in a policyholder database; and
delivering the one or more articles to a receiving entity.

2. The method as set forth in claim 1, wherein, in response to determining that no match exists between the location parameters and a known source location,
associating the cargo-handling conveyance identifier with a usage-based cargo insurance policy having a second premium rate calculated by the policy management system, wherein the second premium rate is different from the first premium rate, and
storing the second premium rate in the policyholder database.

3. The method as set forth in claim 1, further comprising:
issuing a unique cargo identifier for the cargo; and
associating the unique cargo identifier with the usage-based cargo insurance policy in the policyholder database.

4. (canceled)

5. The method as set forth in claim 1, further comprising, upon delivery of the one or more articles to a receiving entity, verifying that the one or more article identifiers accurately represent the cargo.

6. The method as set forth in claim 1, further comprising:
transmitting one or more cargo quantifiers of the cargo over the communications network; and
adjusting the first premium rate based at least in part on the one or more cargo quantifiers.

7. The method as set forth in claim 1, further comprising:
obtaining from an equipment components database failure risks associated with one or more equipment components of the cargo-handling conveyance; and
comparing the failure risks with a failure risk threshold.

8. The method as set forth in claim 7, further comprising, in response to discovering the threshold is greater than the failure risks, scaling the first premium rate in accordance with the failure risks.

9. The method as set forth in claim 7, wherein, in response to discovering the failure risks exceed the threshold, revoking the usage-based insurance policy and disassociating the unique cargo-handling conveyance identifier from the usage-based insurance policy in the policyholder database.

10. A computer program product for managing transportation of cargo in accordance with a usage-based insurance policy for a cargo-handling conveyance, the computer program product residing on a non-transitory computer-readable storage medium and comprising instructions which, when executed by a processor cause one or more computers to:
record a unique cargo-handling conveyance identifier for the cargo-handling conveyance;
record data regarding a cargo collected by the cargo-handling conveyance, the cargo comprising one or more articles;
obtain, from a Global Positioning System sensor on the cargo-handling conveyance, location parameters of the cargo-handling conveyance;
obtain, by scanning one or more barcodes representing the one or more articles on the cargo-handling conveyance, one or more article identifiers representing the one or more articles;
request usage-based insurance of the cargo by transmitting, over a communications network, the location parameters and the one or more article identifiers;
obtain known source locations of the one or more articles from a source location database;
obtain an environmental hostility score for the location parameters;
determining whether the known source locations match the location parameters;
in response to determining that a match exists between the location parameters and a known source location,
associate the cargo-handling conveyance identifier with a usage-based cargo insurance policy having a first premium rate, wherein the first premium rate is based at least in part on the environmental hostility score, and
store the first premium rate in a policyholder database; and
recording a delivery of the one or more articles to a receiving entity.

11. The computer program product as set forth in claim 10, wherein, in response to determining that no match exists between the location parameters and a known source location, the instructions further cause one or more computers to:
associate the cargo-handling conveyance identifier with a usage-based cargo insurance policy having a second premium rate calculated by the policy management system, wherein the second premium rate is different from the first premium rate, and
store the second premium rate in the policyholder database.

12. The computer program product as set forth in claim 10, wherein the instructions further cause one or more computers to:
issue a unique cargo identifier for the cargo; and
associate the unique cargo identifier with the usage-based cargo insurance policy in the policyholder database.

13. (canceled)

14. The computer program product as set forth in claim 10, wherein, upon delivery of the cargo to a receiving entity, the instructions further cause one or more computers to verify that the one or more article identifiers accurately represent the cargo.

15. The computer program product as set forth in claim 10, wherein the instructions further cause one or more computers to:
transmit one or more cargo quantifiers of the cargo over the communications network; and
adjust the first premium rate based at least in part on the one or more cargo quantifiers.

16. The computer program product as set forth in claim 10, wherein the instructions further cause the one or more computers to:
obtain from an equipment components database failure risks associated with one or more equipment components of the cargo-handling conveyance; and
compare the failure risks with a failure risk threshold.

17. The computer program product as set forth in claim 16, the instructions further cause the one or more computers to, in response to discovering the threshold is greater than the failure risks, scale the first premium rate in accordance with the failure risks.

18. The computer program product as set forth in claim 16, wherein the instructions further cause the one or more computers to, in response to discovering the failure risks exceed the threshold, revoke the usage-based insurance policy and disassociate the unique cargo-handling conveyance identifier from the usage-based insurance policy in the policyholder database.

19. A system for managing transportation of cargo in accordance with a usage-based insurance policy for a cargo-handling conveyance, comprising:
a pre-registration server configured to record a unique cargo-handling conveyance identifier for the cargo-handling conveyance;
a Global Positioning System sensor configured to obtain location parameters of the cargo-handling conveyance;
a registration client configured to:
collect, by the cargo-handling conveyance, a cargo comprising one or more articles, and
request usage-based insurance of a cargo collected by the cargo-handling conveyance, wherein the cargo includes one or more articles, and wherein the request for usage-based insurance is done by transmitting, over a communications network, the location parameters and the one or more article identifiers;
a scanner configured to scan barcodes of the one or more articles to obtain the one or more article identifiers and transmit the one or more article identifiers to the registration client;
a source search engine configured to:
obtain known source locations of the one or more articles from a source location database, and
obtain an environmental hostility score for the location parameters;
a comparison engine configured to determining whether the known source locations match the location parameters; and
an underwriting engine configured to, in response to determining that a match exists between the location parameters and a known source location:
associate the cargo-handling conveyance identifier with a usage-based cargo insurance policy having a first premium rate, wherein the first premium rate is based at least in part on the environmental hostility score, and
store the first premium rate in a policyholder database.

20. The system as set forth in claim 19, wherein, in response to the comparison engine determining that no match exists between the location parameters and a known source location, the underwriting engine is further configured to:
associate the cargo-handling conveyance identifier with a usage-based cargo insurance policy having a second premium rate calculated by the policy management system, wherein the second premium rate is different from the first premium rate, and
store the second premium rate in the policyholder database.

21. The system as set forth in claim 19, further comprising an assignment server configured to issue a unique cargo identifier for the cargo and associate the unique cargo identifier with the usage-based cargo insurance policy in the policyholder database.

22. (canceled)

23. The system as set forth in claim 19, further comprising a validation engine configured to, upon delivery of the cargo to a receiving entity, verify that the one or more article identifiers accurately represent the cargo.

24. The system as set forth in claim 19, wherein:
the registration client is further configured to transmit one or more cargo quantifiers over the communications network; and
a quantity scaling component configured to adjust the first premium rate based at least in part on the one or more cargo quantifiers.

25. The system as set forth in claim 19, wherein
the system further comprises:
an equipment component search engine configured to obtain from an equipment components database failure risks associated with one or more equipment components of the cargo-handling conveyance; and
an analysis engine configured to compare the failure risks with a failure risk threshold.

26. The system as set forth in claim 25, wherein the underwriting engine is further configured to revoke the usage-based insurance policy and disassociate the unique cargo-handling conveyance identifier from the usage-based insurance policy in the policyholder database in response to discovery by the analysis engine that the failure risks exceed the failure risk threshold.

27. The system as set forth in claim 25, wherein the underwriting engine is further configured to scale the first premium rate in accordance with the failure risks in response to discovery by the analysis engine that the threshold is greater than the failure risks.

28. A method for transporting a catch in accordance with a usage-based insurance policy for a fishing vessel, comprising:
recording a unique fishing vessel identifier for the fishing vessel;
collecting, by the fishing vessel, a catch comprising one or more fish species;
obtaining, by a Global Positioning System sensor on the fishing vessel, location parameters of the fishing vessel;
obtaining, by scanning one or more barcodes representing the one or more fish species, one or more fish species identifiers representing the one or more fish species;
requesting usage-based insurance of the catch by transmitting, over a communications network, the location parameters and the identifiers for the one or more fish species;
obtaining known ranges of the one or more fish species from a range database;
obtaining an environmental hostility score for the location parameters;
determining whether the known ranges match the location parameters;
in response to determining that a match exists between the location parameters of the fishing vessel and known ranges,
associating the fishing vessel identifier with a usage-based insurance policy having a first premium rate, wherein the first premium rate is based at least in part on the environmental hostility score; and
storing the first premium rate in a policyholder database; and
delivering the catch to a receiving entity.

29. The method as set forth in claim 28, further comprising:
transmitting, over the communications network, a collection process for the fish species;
querying, using the collection process for the one or more fish species, a responsible collection process database to obtain one or more responsible collection processes;
comparing the collection process for the one or more fish species with the one or more responsible collection processes; and
in response to finding no match between the collection process of the catch and a responsible collection process as returned by the querying using the collection process, revoking the usage-based insurance policy and disassociating the unique fishing vessel identifier from the usage-based insurance policy in the policyholder database.

30. The method as set forth in claim 28, further comprising:
obtaining from an equipment components database failure risks associated with one or more equipment components of the fishing vessel; and
comparing the failure risks with a failure risk threshold.
